(19) United States
(12) Patent Application Publication
(10) Pub. No.: US 2024/0255922 A1
(43) Pub. Date: Aug. 1, 2024

(54) CONTROL DEVICE AND CONTROL METHOD

(71) Applicant: FANUC CORPORATION, Minamitsuru-gun, Yamanashi (JP)

(72) Inventor: Shinichi NODA, Yamanashi (JP)

(21) Appl. No.: 18/289,637

(22) PCT Filed: Jun. 18, 2021
(86) PCT No.: PCT/JP2021/023258

§ 371 Date: Nov. 6, 2023

(51) Int. Cl. G05B 19/4155

(52) U.S. Cl. CPC G05B 19/4155; G05B 2219/33139

(57) ABSTRACT

The purpose of the present invention is to achieve multilevel priority without preparing in advance the necessary amount of tasks for the priority levels. A control device according to the present invention performs a process on a processing request from a client for an industrial machine, said control device comprising: a priority analysis unit that, when receiving the processing request from the client, analyzes the priority which is set for the received processing request; and a priority change unit that changes the priority with respect to the received processing request on the basis of the result of the analysis by the priority analysis unit.

### TECHNICAL FIELD

The present invention relates to a control device and a control method.

### BACKGROUND ART

In control devices for industrial machines capable of issuing commands from an application via a communication interface, it was conventionally not possible to designate priorities to the commands, and therefore periodic maintenance processes (such as backups and the like) would sometimes interfere with more important control processes, affecting the control processes.

In this regard, there has been proposed a control device including a communication interface for receiving an operation request transmitted via a network, and a sub-CPU and a main CPU for analyzing the received operation request and executing a process according to an analysis result, wherein the sub-CPU and the main CPU distribute communication tasks allocated to communication processing via a network connection interface to a high-speed communication task used for a high-speed response from a reception of the operation request to execution of the process according to the analysis result, and a normal communication task other than the high-speed communication task, and preferentially perform the high-speed communication task for a control task allocated to control of a machine tool at an internal control cycle. For example, see Patent Document 1.

In addition, there has been proposed a control device wherein, by setting the priority associated with the process for interpreting the application program and generating the internal command to be changed in a higher direction, the calculation time or the processor resource allocated to the process can be increased. For example, see Patent Document 2.
Patent Document 1: Japanese Unexamined Patent Application, Publication No. 2015-215669
Patent Document 2: Japanese Unexamined Patent Application, Publication No. 2019-067046

### DISCLOSURE OF THE INVENTION

### Problems to be Solved by the Invention

Patent Document 1 only has two priorities, namely the normal communication task and the high-speed communication task, which is not enough to determine priorities for a plurality of applications, and there is a need for a priority level design with a high degree of freedom, such as, for example “control>monitoring>recording>periodic maintenance (backup)”, or the like.

However, the invention of Patent Document 1 distributes tasks having determined priorities, and therefore there is a need to prepare in advance the necessary number of tasks for the necessary priority levels, which is a hindrance to achieving multilevel priority.

There is thus a demand for achieving multilevel priority without preparing in advance the necessary number of tasks for the priority levels.

### Means for Solving the Problems

An aspect of a control device according to the present disclosure is a control device for executing a process on a processing request from a client for an industrial machine, the control device including: a priority analysis unit configured to, upon receiving the processing request from the client, perform an analysis of a priority that is set for the received processing request; and a priority change unit configured to change the priority with respect to the received processing request on the basis of a result of the analysis by the priority analysis unit.

An aspect of a control method according to the present disclosure is a control method for executing a process on a processing request from a client for an industrial machine, the method including: upon receiving the processing request from the client, performing an analysis of a priority that is set for the received processing request; and changing the priority with respect to the received processing request, on the basis of a result of the analysis of the priority.

### Effects of the Invention

According to an aspect of the present disclosure, multilevel priority can be achieved without preparing in advance the necessary number of tasks for the priority levels.

### BRIEF DESCRIPTION OF THE DRAWINGS

FIG. 1 is a functional block diagram illustrating an example of a functional configuration of a control system according to a first embodiment;

FIG. 2 is a flowchart describing a control process of a numerical control device;

FIG. 3 is a functional block diagram illustrating an example of a functional configuration of a control system according to a second embodiment;

FIG. 4 is a flowchart describing a control process of a numerical control device;

FIG. 5 is a functional block diagram illustrating an example of a functional configuration of a control system according to a third embodiment; and

FIG. 6 is a flowchart describing a control process of a numerical control device.

### PREFERRED MODE FOR CARRYING OUT THE INVENTION

First to third embodiments will be described in detail with reference to the drawings.

The embodiments share the feature of executing a processing request from a client according to a priority.

However, regarding the designation of the priority, in the first embodiment, the priority is explicitly designated on the basis of an input operation by a user when the processing request command is generated at the client. By contrast, the second embodiment differs from the first embodiment in that the priority is not designated with respect to the processing request when the processing request command is generated at the client, but the priority is implicitly designated with respect to the processing request on the basis of a priority for each processing request that is set in advance in the control device. In addition, the third embodiment differs from the first embodiment and the second embodiment in that the priority is designated with respect to the processing request on the basis of a combination of an explicit priority designated on the basis of an input operation by a user when the processing request command is generated at the client, and an implicit priority for each processing request that is set in advance in the control device.

Below, the first embodiment is described in detail, and then particularly the portions of the second embodiment and the third embodiment that differ from the first embodiment are described.

### FIRST EMBODIMENT

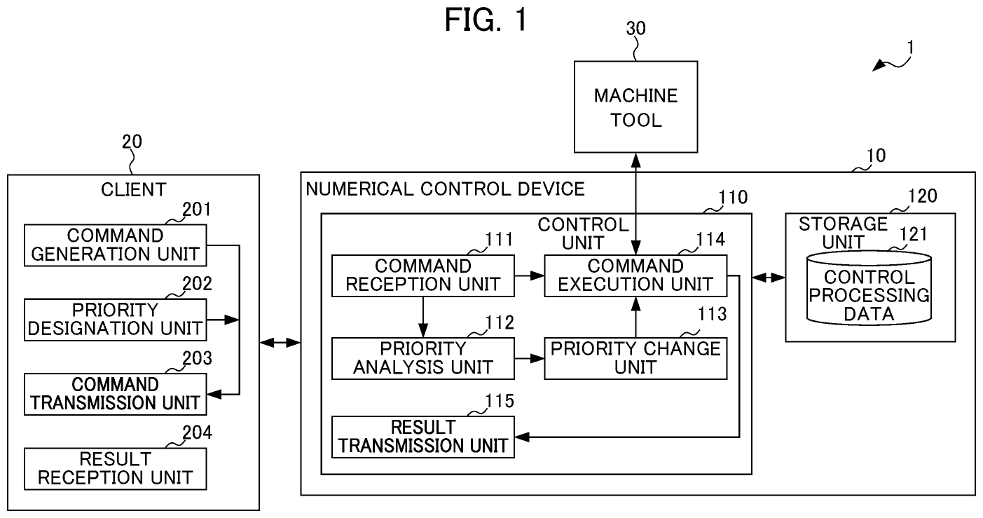

FIG. 1 is a functional block diagram illustrating an example of a functional configuration of a control system according to the first embodiment. Here, by way of example, a machine tool is described as an industrial machine, and a numerical control device is described as a control device. It should be noted that the present invention is not limited to a machine tool and a numerical control device, and may also be applied to industrial machines such as, for example, an injection molding machine, an industrial robot, and a service robot, or the like, and to a robot control device for controlling an industrial robot or the like.

As illustrated in FIG. 1, a control system 1 has a numerical control device 10, a client 20, and a machine tool 30.

The numerical control device 10, the client 20, and the machine tool 30 are directly connected to one another via a connection interface not illustrated here. In addition, the numerical control device 10, the client 20, and the machine tool 30 may be connected to one another via a network not illustrated here, such as a local area network (LAN), or the like. In this case, the numerical control device 10, the client 20, and the machine tool 30 each include a communication unit not illustrated here for communicating with one another through said connection.

### <Machine Tool 30>

The machine tool 30 is a machine tool that is known to a person skilled in the art, and operates on the basis of operation commands from the numerical control device 10 as a control device.

### <Client 20>

The client 20 is, for example, a display or a tablet or the like.

As illustrated in FIG. 1, the client 20 has a command generation unit 201, a priority designation unit 202, a command transmission unit 203, and a result reception unit 204.

It should be noted that in order to achieve the operations of the functional blocks in FIG. 1, the client 20 is provided with an arithmetic processing device not illustrated here, such as a central processing unit (CPU) or the like. In addition, the client 20 is provided with an auxiliary storage device not illustrated here, such as a ROM or an HDD or the like storing various control programs, and a main storage device not illustrated here, such as a random-access memory (RAM) for storing data that is temporarily needed for the arithmetic processing device to execute a program.

In the client 20, the arithmetic processing device reads an OS or an application software from the auxiliary storage device, and performs arithmetic processing on the basis of the OS or application software while running the read OS or application software in the main storage device. The client 20 controls various hardware on the basis of the arithmetic processing. The processes by the functional blocks in FIG. 1 are thus achieved. That is to say, the client 20 may be realized by cooperation of software and hardware.

The command generation unit 201 receives an input of a processing request or the like from a user via an input device (not illustrated here) such as, for example, a keyboard or a touch panel included in the client 20, and generates a command for the received processing request.

The priority designation unit 202 receives a designation of a priority with respect to the processing request generated by the command generation unit 201, on the basis of, for example, an input operation by the user with respect to the input device (not illustrated here) of the client 20, and adds a priority to the arguments of an application programming interface (API) function executed from the client 20.

This makes it possible to clearly indicate the priority when the API function is called. In other words, when the numerical control device 10 described below has received a processing request from the client 20, the priority of the received processing request can be explicitly seen by calling the API function.

The designation method for the priority is not limited to a function basis, but designation may be made on a communication session basis, an application basis, a client host basis, a logged-in user basis, or the like. For example, a function that designates a priority with respect to a specific element, such as change_priority_by_application (application_id, new_priority) may be prepared. However, for the session basis, the arguments of the session start function may be added at the time of an open session.

The command transmission unit 203 transmits the processing request generated by the command generation unit 201 to the numerical control device 10 described below.

The result reception unit 204 receives, from the numerical control device 10 described below, a processing result with respect to the processing request transmitted by the command transmission unit 203. The result reception unit 204 may display the received processing result on, for example, a display unit (not illustrated here) such as a liquid crystal display of the client 20.

### <Numerical Control Device 10>

The numerical control device 10 is a numerical control device known to a person skilled in the art, and generates an operation command on the basis of a processing request from the client 20, or a machining program acquired from an external device (not illustrated here) such as a CAD/CAM device, and transmits the generated operation command to the machine tool 30. The numerical control device 10 thus controls the operation of the machine tool 30. When the machine tool 30 is a robot or the like, the numerical control device 10 may be a robot control device or the like.

As illustrated in FIG. 1, the numerical control device 10 has a control unit 110, and a storage unit 120. Further, the control unit 110 has a command reception unit 111, a priority analysis unit 112, a priority change unit 113, a command execution unit 114, and a result transmission unit 115.

### <Storage Unit 120>

The storage unit 120 is a RAM, a hard disk drive (HDD), or the like. The storage unit 120 stores control processing data 121.

The control processing data 121 stores, for example, a machining program generated by an external device (not illustrated here) such as a CAD/CAM device, or set values such as a tool compensation amount and workpiece coordinates.

### <Control Unit 110>

The control unit 110 is a unit known to a person skilled in the art, and has a CPU, a read-only memory (ROM), a RAM, a complementary metal-oxide-semiconductor (CMOS) memory, and the like, which are configured to be able to communicate with one another via a bus.

The CPU is a processor that controls the entirety of the numerical control device 10. The CPU reads a system program and an application program stored in the ROM via the bus, and controls the entirety of the numerical control device 10 according to the system program and the application program. Thus, as illustrated in FIG. 1, the control unit 110 is configured to achieve the functions of the command reception unit 111, the priority analysis unit 112, the priority change unit 113, the command execution unit 114, and the result transmission unit 115. The RAM stores various data such as temporary calculation data and display data. In addition, the CMOS memory is configured as a non-volatile memory that is backed up by a battery not illustrated here, such that the storage state is retained even when the power source of the numerical control device 10 is turned off.

The command reception unit 111 is, for example, a web server (not illustrated here) that communicates with the client 20. Upon receiving the processing request with respect to the numerical control device 10 from the client 20, the command reception unit 111 outputs the processing request to the priority analysis unit 112 and the command execution unit 114 described below.

Upon receiving the processing request from the client 20, the priority analysis unit 112 analyzes a priority set for the received processing request.

Specifically, the priority analysis unit 112, for example, calls the API function executed upon generation of the received processing request by the client 20, and acquires the priority of the processing command set as an argument of the API function. The priority analysis unit 112 outputs the acquired priority as an analysis result to the priority change unit 113.

The priority change unit 113 changes the priority with respect to the received processing request on the basis of the analysis result from the priority analysis unit 112. The priority change unit 113 sets the changed priority for the processing request in the command execution unit 114 described below.

The command execution unit 114 executes the task of the processing request received via the command reception unit 111, on the basis of the priority changed by the priority change unit 113.

Specifically, the command execution unit 114 executes the task of the received processing request on the basis of the changed priority, while exchanging data with the control processing data 121 and the machine tool 30, etc.

Thus, the numerical control device 10 is able to achieve multilevel priority without preparing in advance the necessary number of tasks for the priority levels.

The result transmission unit 115 is, for example, a web server (not illustrated here), and transmits the execution result of the processing request executed by the command execution unit 114 to the client 20.

### <Control Process of Numerical Control Device 10>

Next, operations pertaining to a control process of the numerical control device 10 according to the present embodiment will be described.

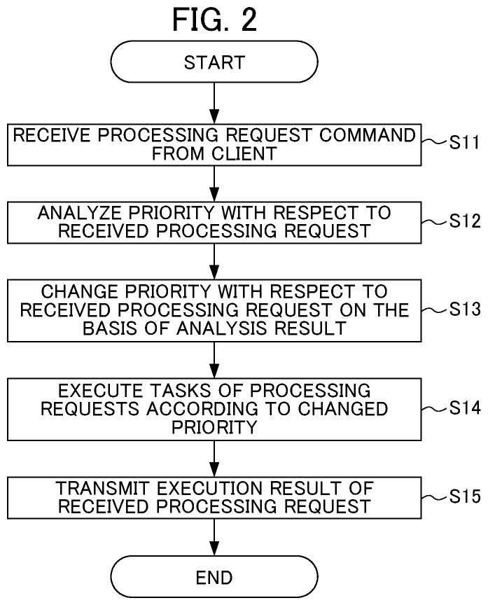

FIG. 2 is a flowchart describing the control process of the numerical control device 10.

At Step S11, the command reception unit 111 receives a processing request with respect to the numerical control device 10 from the client 20. The command reception unit 111 outputs a command for the received processing request to the priority analysis unit 112 and the command execution unit 114.

At Step S12, the priority analysis unit 112 analyzes a priority set for the processing request received at Step S11, by calling an API function executed by the client 20 when generating the processing request received at Step S11.

At Step S13, the priority change unit 113 changes the priority with respect to the processing request received at Step S11, on the basis of a result of the analysis at Step S12.

At Step S14, the command execution unit 114 executes a task of the processing request received at Step S11, on the basis of the priority changed at Step S13.

At Step S15, the result transmission unit 115 transmits the execution result of the process request executed at Step S14 to the client 20.

Due to the above, the numerical control device 10 according to the first embodiment is able to achieve multilevel priority without preparing in advance the necessary number of tasks for the priority levels, by explicitly designating the priority with respect to the processing request generated by the client 20. That is to say, in the numerical control device 10 capable of issuing a command from an application via a communication interface, the priority of the command can be designated, unlike in the conventional art, and therefore, tasks having a high priority can be preferentially performed over tasks having a low priority.

This concludes the description of the first embodiment.

### SECOND EMBODIMENT

Next, a second embodiment will be described. As described above, regarding the designation of the priority, in the first embodiment, the priority is explicitly designated on the basis of an input operation by a user when the processing request command is generated at the client 20. By contrast, the second embodiment differs from the first embodiment in that the priority is not designated with respect to the processing request when the processing request command is generated at a client 20A, but the priority is implicitly designated with respect to the processing request on the basis of a priority for each processing request that is set in advance in a numerical control device 10A.

Thus, the numerical control device 10A is able to achieve multilevel priority without preparing in advance the necessary number of tasks for the priority levels.

The second embodiment is described below.

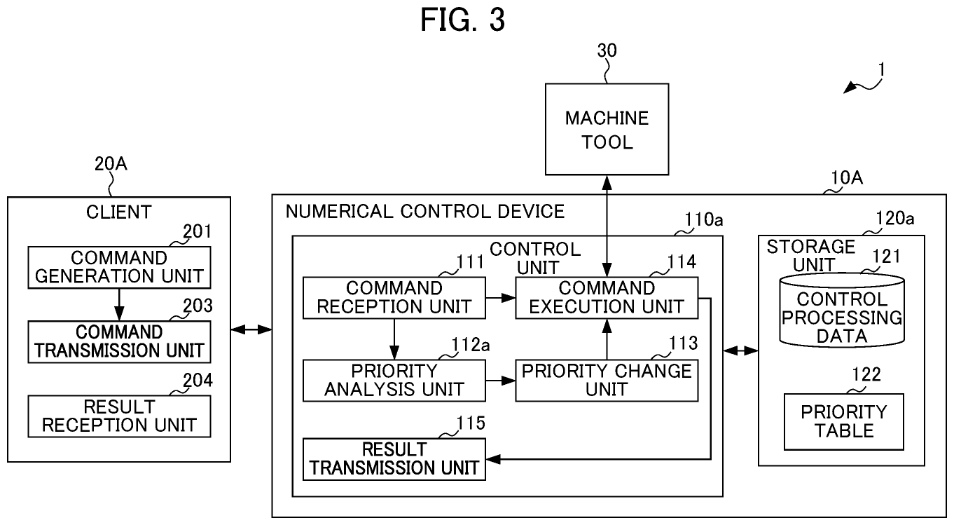

FIG. 3 is a functional block diagram illustrating an example of a functional configuration of a control system according to the second embodiment. Elements that have the same functions as the elements of the control system 1 illustrated in FIG. 1 are given the same reference numerals, and detailed description thereof is omitted.

As illustrated in FIG. 3, the control system 1 has a numerical control device 10A, a client 20A, and a machine tool 30.

### <Client 20A>

The client 20A according to the second embodiment has an equivalent configuration to that of the client 20 in the first embodiment.

That is to say, as illustrated in FIG. 3, the client 20A has a command generation unit 201, a command transmission unit 203, and a result reception unit 204.

The command generation unit 201, the command transmission unit 203, and the result reception unit 204 have equivalent functions to those of the command generation unit 201, the command transmission unit 203, and the result reception unit 204 in the first embodiment. That is to say, the client 20A transmits the generated processing request to the numerical control device 10A described below, without designating a priority with respect to the processing request.

### <Numerical Control Device 10A>

The numerical control device 10A according to the second embodiment has an equivalent configuration to that of the numerical control device 10 in the first embodiment.

That is to say, as illustrated in FIG. 3, the numerical control device 10A has a control unit 110a, and a storage unit 120a. Further, the control unit 110a has a command reception unit 111, a priority analysis unit 112a, a priority change unit 113, a command execution unit 114, and a result transmission unit 115. In addition, the storage unit 120a stores control processing data 121, and a priority table 122.

The command reception unit 111, the priority change unit 113, the command execution unit 114, and the result transmission unit 115 have equivalent functions to those of the command reception unit 111, the priority change unit 113, the command execution unit 114, and the result transmission unit 115 in the first embodiment.

In addition, the control processing data 121 is equivalent to the control processing data 121 in the first embodiment.

The priority table 122 is data in which a priority with which the command execution unit 114 is to execute the processing request received from the client 20A is implicitly set in advance for each processing request.

The priority table 122 may be set on a communication session basis, an application basis, a client host basis, a logged-in user basis, and the like.

For example, when the priority table 122 is set on an application basis, an application set having a high (or low) priority may be determined on the basis of an application identifier (ID or name). Alternatively, when the priority table 122 is set on a client host basis, a client host set having a high (or low) priority may be determined on the basis of separately registered roles (a display, supervisory control and data acquisition (SCADA), and the like). Alternatively, when the priority table 122 is set on a user basis, a user set having a high (or low) priority may be determined on the basis of a user ID or a group ID.

When, for example a processing request has been received from the client 20A, the priority analysis unit 112a analyzes the priority with respect to the received processing request on the basis of the priority table 122. The priority analysis unit 112a outputs the acquired priority as an analysis result to the priority change unit 113.

### <Control Process of Numerical Control Device 10A>

Next, operations pertaining to a control process of the numerical control device 10A according to the second embodiment will be described.

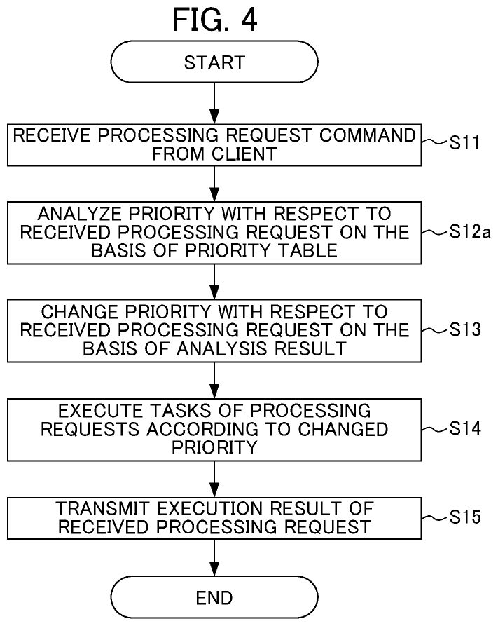

FIG. 4 is a flowchart describing the control process of the numerical control device 10A.

It should be noted that the processes at Step S11 and from Step S13 to Step S15 are the same as in Step S11 and Step S13 to Step S15 of the first embodiment illustrated in FIG. 2, and detailed description thereof is omitted.

At Step S12a, the priority analysis unit 112a analyzes the priority with respect to the processing request received from the client 20A at Step S11, on the basis of the priority table 122.

Due to the above, the numerical control device 10A according to the second embodiment is able to achieve multilevel priority without preparing in advance the necessary number of tasks for the priority levels, by implicitly designating the priority with respect to the processing request command received from the client 20A, on the basis of the priority table 122.

This concludes the description of the second embodiment.

### THIRD EMBODIMENT

Next, a third embodiment will be described. As described above, regarding the designation of the priority, the third embodiment differs from the first embodiment and the second embodiment in that the priority is designated with respect to the processing request on the basis of a combination of an explicit priority designated on the basis of an input operation by a user when the processing request command is generated at the client 20, and an implicit priority for each processing request that is set in advance in a numerical control device 10B.

Thus, the numerical control device 10B is able to achieve multilevel priority without preparing in advance the necessary number of tasks for the priority levels.

The third embodiment is described below.

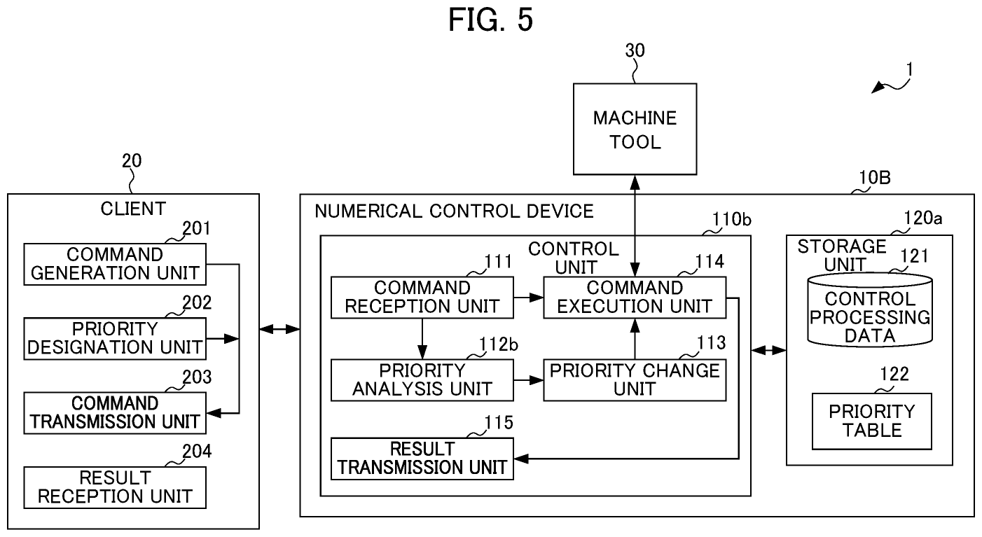

FIG. 5 is a functional block diagram illustrating an example of a functional configuration of a control system according to the third embodiment. Elements that have the same functions as the elements of the control system 1 illustrated in FIGS. 1 and 3 are given the same reference numerals, and detailed description thereof is omitted.

As illustrated in FIG. 5, the control system 1 has a numerical control device 10B, a client 20, and a machine tool 30.

The client 20 and the machine tool 30 have equivalent configurations to those of the client 20 and the machine tool 30 in the first embodiment.

### <Numerical Control Device 10B>

The numerical control device 10B according to the third embodiment has an equivalent configuration to that of the numerical control device 10 in the first embodiment.

That is to say, as illustrated in FIG. 5, the numerical control device 10B has a control unit 110b, and a storage unit 120a. Further, the control unit 110b has a command reception unit 111, a priority analysis unit 112b, a priority change unit 113, a command execution unit 114, and a result transmission unit 115. In addition, the storage unit 120a stores control processing data 121, and a priority table 122.

The command reception unit 111, the priority change unit 113, the command execution unit 114, and the result transmission unit 115 have equivalent functions to those of the command reception unit 111, the priority change unit 113, the command execution unit 114, and the result transmission unit 115 in the first embodiment.

In addition, the control processing data 121 and the priority table 122 are equivalent to the control processing data 121 and the priority table 122 in the second embodiment.

Upon receipt of a processing request from the client 20, the priority analysis unit 112b analyzes the priority with respect to the received processing request, on the basis of a combination of an explicit priority designated by the client 20, and an implicit priority based on the priority table 122.

Specifically, for example, upon receipt of the processing request from the client 20, the priority analysis unit 112b, like the priority analysis unit 112 of the first embodiment, calls the API function executed upon generation of the received processing request, and thereby acquires the priority of the processing command set as an argument of the API function as an explicit priority. In addition, like the priority analysis unit 112a of the second embodiment, the priority analysis unit 112b acquires the priority with respect to the received processing request as an implicit priority, on the basis of the priority table 122. The priority analysis unit 112b calculates the priority with respect to the received processing request, using the acquired explicit priority and implicit priority, and a predefined function F(a, b). Here, a represents the explicit priority, and b represents the implicit priority. The priority analysis unit 112b outputs the priority calculated with respect to the received processing request as an analysis result to the priority change unit 113.

The function F(a, b) may be defined as, for example, a ratio change a×b/C (where C is a constant), a weighted offset change a+(b/C), a geometric mean (a×b)^{1/2}, and the like.

### <Control Process of Numerical Control Device 10B>

Next, operations pertaining to a control process of the numerical control device 10B according to the third embodiment will be described.

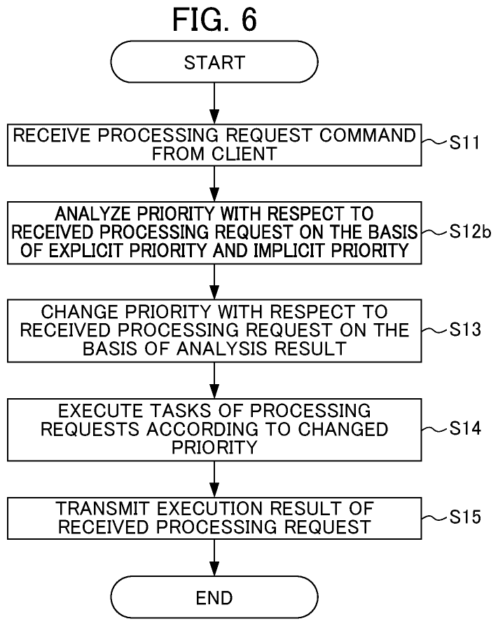

FIG. 6 is a flowchart describing the control process of the numerical control device 10B.

It should be noted that the processes at Step S11 and from Step S13 to Step S15 are the same as in Step S11 and from Step S13 to Step S15 of the first embodiment illustrated in FIG. 2, and detailed description thereof is omitted.

At Step S12b, the priority analysis unit 112b analyzes the priority with respect to the processing request command received at Step S11, on the basis of a combination of the explicit priority designated by the client 20, and the implicit priority based on the priority table 122.

Due to the above, the numerical control device 10B according to the third embodiment is able to achieve multilevel priority without preparing in advance the necessary number of tasks for the priority levels, setting the priority with respect to the processing request command received from the client 20, on the basis of a combination of the explicit priority designated by the client 20 and the implicit priority based on the priority table 122.

This concludes the description of the third embodiment.

The first, second, and third embodiments are described above, but the numerical control device 10, 10A, 10B is not limited to the above embodiments, and include variants and modifications within the scope capable of achieving the purpose.

### MODIFIED EXAMPLE 1

In the first, second, and third embodiments, the numerical control device 10, 10A, 10B preferentially executes tasks having a high priority over tasks having a low priority, but the present invention is not so limited. For example, in the case of a multitask system, the numerical control device 10, 10A, 10B may execute low-priority tasks while waiting for the I/O for high-priority tasks, and therefore, unlike simply executing tasks in order of priority, the multilevel priority may improve processing performance per unit time.

### MODIFIED EXAMPLE 2

As another example, in the first embodiment, the numerical control device 10 is configured to add the priority to the arguments of the API function executed from the client 20, making it possible to clearly indicate the priority when the API function is called, but the present invention is not so limited. For example, the numerical control device 10 may designate on a communication session basis, an application basis, a client host basis, a logged-in user basis, or the like.

### MODIFIED EXAMPLE 3

As another example, in the second embodiment, the numerical control device 10A does not receive information about the priority along with the processing request command from the client 20A in the case of implicit priority designation, but the present invention is not so limited. For example, the numerical control device 10A may have the function of the priority designation unit 202.

The functions included in the numerical control device 10, 10A, 10b according to the first, second, and third embodiments may be realized by hardware, software, or a combination thereof. Here, being “realized by software” means being realized by a computer reading and executing a program.

The program may be stored using various types of non-transitory computer-readable media and provided to a computer. Non-transitory computer-readable media include various types of tangible storage media. Examples of non-transitory computer-readable media include magnetic storage media (e.g., flexible discs, magnetic tapes, hard disk drives), magneto-optical storage media (e.g., magneto-optical discs), CD-ROM (Read Only Memory), CD-R, CD-R/W, semiconductor memories (e.g., mask ROM, PROM (Programmable ROM), EPROM (Erasable PROM), flash ROM, and RAM). In addition, the program may be provided to the computer by various types of transitory computer-readable media. Examples of transitory computer-readable media include electric signals, optical signals, and electromagnetic waves. Transitory computer-readable media may provide the program to the computer via wired communication paths such as electric wires and optical fibers, etc., or via wireless communication paths.

It should be noted that the steps describing the program stored in the storage medium include a process executed chronologically according to the order thereof, and also includes processes executed in parallel or separately, and not necessarily in chronological order.

Rephrasing the above description, the control device and the control method according to the present disclosure may take on various embodiments having the following configurations.
(1) The numerical control device 10 according to the present disclosure is a control device for executing a process on a processing request from a client 20 for an industrial machine, the control device including: a priority analysis unit 112 configured to, upon receiving the processing request from the client 20, analyze a priority that is set for the received processing request; and a priority change unit 113 configured to change the priority with respect to the received processing request on the basis of a result of the analysis by the priority analysis unit 112.

According to this numerical control device 10, multilevel priority can be achieved without preparing in advance the necessary number of tasks for the priority levels.
(2) In the numerical control device 10 according to (1), the priority that is set for the processing request may be an explicit priority that is designated by the client 20.

Thus, the numerical control device 10 is able to achieve multilevel priority without preparing in advance the necessary number of tasks for the priority levels, by having the client 20 explicitly designate the priority with respect to the generated processing request.
(3) In the numerical control device 10A according to (1), the priority that is set for the processing request may be an implicit priority that is set in advance.

Thus, the numerical control device 10A is able to achieve multilevel priority without preparing in advance the necessary number of tasks for the priority levels, by implicitly designating the priority with respect to the processing request command received from the client 20.
(4) In the numerical control device 10B according to (1), the priority that is set for the processing request may be a combination of an explicit priority designated by the client 20, and an implicit priority that is set in advance.

Thus, the numerical control device 10B is able to achieve multilevel priority without preparing in advance the necessary number of tasks for the priority levels, by setting the priority with respect to the processing request command on the basis of a combination of an explicit priority designated by the client 20 and an implicit priority that is set in advance.
(5) In the numerical control device 10, 10A, 10B according to any of (1) to (4), the industrial machine may be a machine tool 30, and the control device may be a numerical control device 10, 10A, 10B.

Thus, when the industrial machine is a machine tool 30, the effects of (1) to (4) can be achieved.
(6) In the control device according to any of (1) to (4), the industrial machine may be an industrial robot, and the control device may be a robot control device.

Thus, when the industrial machine is an industrial robot, the effects of (1) to (4) can be achieved.
(7) The control method according to the present disclosure is a control method for executing a process on a processing request from a client 20 for an industrial machine, the method including: upon receiving the processing request from the client 20, analyzing a priority that is set for the received processing request; and changing the priority with respect to the received processing request, on the basis of a result of the analysis of the priority.

According to this control method, the same effect as in (1) can be achieved.

### EXPLANATION OF REFERENCE NUMERALS

1 Control system
10, 10A, 10B Numerical control device
110 Control unit
111 Command reception unit
112 Priority analysis unit
113 Priority change unit
114 Command execution unit
115 Result transmission unit
120 Storage unit
121 Control processing data
122 Priority table
20 Client
201 Command generation unit
202 Priority designation unit
203 Command transmission unit
204 Result reception unit
30 Machine tool

1. A control device for executing a process on a processing request from a client for an industrial machine, the control device comprising:
a priority analysis unit configured to, upon receiving the processing request from the client, perform an analysis of a priority that is set for the received processing request; and
a priority change unit configured to change the priority with respect to the received processing request on the basis of a result of the analysis by the priority analysis unit.

2. The control device according to claim 1, wherein the priority that is set for the processing request is an explicit priority that is designated by the client.

3. The control device according to claim 1, wherein the priority that is set for the processing request is an implicit priority that is set in advance.

4. The control device according to claim 1, wherein the priority that is set for the processing request is a combination of an explicit priority designated by the client, and an implicit priority that is set in advance.

5. The control device according to claim 1, wherein the industrial machine is a machine tool, and the control device is a numerical control device.

6. The control device according to claim 1, wherein the industrial machine is an industrial robot, and the control device is a robot control device.

7. A control method for executing a process on a processing request from a client for an industrial machine, the method comprising:
Upon receiving the processing request from the client, performing an analysis of a priority that is set for the received processing request; and
changing the priority with respect to the received processing request, on the basis of a result of the analysis of the priority.
